(19) United States
(12) Patent Application Publication
(10) Pub. No.: US 2026/0009292 A1
(43) Pub. Date: Jan. 8, 2026

(54) CORDLESS ROLLER BLIND AND RESISTANCE MECHANISM THEREOF

(71) Applicant: Ya-Yin LIN, Chiayi City (TW)

(72) Inventor: Ya-Yin LIN, Chiayi City (TW)

(21) Appl. No.: 18/763,444

(22) Filed: Jul. 3, 2024

(51) Int. Cl. E06B 9/90; E06B 9/42; E06B 9/60

(52) U.S. Cl. CPC E06B 9/90; E06B 9/42; E06B 9/60

(57) ABSTRACT

A resistance mechanism is adapted to be installed between a winding shaft and a fixed seat of a cordless roller blind, and includes a housing and a resistance module. The housing includes a tubular wall that is hollow and that surrounds an axis which extends in a left-right direction, and an end wall that is connected to one end of the tubular wall. An inner circumferential surface of the tubular wall is provided with a teeth structure that surrounds the axis. The resistance module includes a shaft that extends along the axis through the end wall and that is surrounded by the tubular wall, and a plurality of gears each of which is mounted to the shaft and rotatable relative to the shaft about a rotation axis extending in the left-right direction. The gears are spaced apart along a periphery of the shaft and mesh with the teeth structure.

### FIELD

The disclosure relates to a roller blind, and more particularly to a cordless roller blind and a resistance mechanism thereof.

### BACKGROUND

Referring to FIGS. 1, 2, and 3, a conventional cordless roller blind disclosed in Taiwanese Patent No. 1542307 includes a fixed seat 11 and a hanging seat 12 that are spaced apart from each other and that are mounted to a wall surface (not shown), a winding unit 13 that is mounted to the hanging seat 12, and a roller blind unit 14 that is disposed between the fixed seat 11 and the winding unit 13.

The winding unit 13 includes a shell body 131, and a winding assembly 132 that is disposed in the shell body 131. The winding assembly 132 includes a first gear 133 and a second gear 134 that are rotatably disposed in the shell body 131 and that mesh with each other, and a winding resilient strip 135 that is wound between the first gear 133 and the second gear 134.

The roller blind unit 14 includes a winding shaft 141, a shade cloth 142 that is wound around the winding shaft 141, and a counterweight member 143 that is disposed on one end of the shade cloth 142. The winding shaft 141 has a linking portion 144 that is rotatably inserted into the shell body 131 and that is non-rotatably inserted into the first gear 133, and a mounting portion 145 that rotatably extends into the fixed seat 11.

By a winding resilient force that is provided by the winding resilient strip 135, and by a weight of the counterweight member 143, the roller unit 14 is balanced when no external force is exerted thereon so that the shade cloth 142 may stay in any position after being pushed upwardly or pulled downwardly.

Although the conventional cordless roller blind is operable to fold the shade cloth 142 upwardly or unfold the shade cloth 142 downwardly without a cord, it is necessary to provide a greater selection of cordless roller blinds with different structures to costumers.

### SUMMARY

Therefore, an object of the disclosure is to provide a resistance mechanism having a configuration different from the abovementioned prior art.

According to the disclosure, the resistance mechanism is for a cordless roller blind, is adapted to be installed between a winding shaft and a fixed seat of the cordless roller blind that are rotatable relative to each other, and includes a housing and a resistance module. The housing is adapted to be co-rotatably mounted to the winding shaft. The housing includes a tubular wall that is hollow and that surrounds an axis which extends in a left-right direction, and an in end wall that is connected to one end of the tubular wall. An inner circumferential surface of the tubular wall is provided with a teeth structure that surrounds the axis. The resistance module includes a shaft that extends along the axis through the end wall and that is surrounded by the tubular wall, and a plurality of gears each of which is mounted to the shaft and rotatable relative to the shaft about a rotation axis extending in the left-right direction. The shaft is adapted to be non-rotatably inserted into the fixed seat. The gears are spaced apart along a periphery of the shaft and mesh with the teeth structure. Each of the gears is driven to rotate relative to the shaft by rotation of the teeth structure of the tubular wall when the tubular wall rotates.

Another object of the disclosure is to provide a cordless roller blind having the abovementioned resistance mechanism.

According to the disclosure, the cordless roller blind is adapted to be mounted to a wall surface, and includes a fixed seat, a hanging seat, a roller blind mechanism, and the resistance mechanism as mentioned above. The fixed seat and the hanging seat are spaced apart from each other in a left-right direction, and are adapted to be mounted to the wall surface. The roller blind mechanism includes a winding shaft that extends in the left-right direction and that is disposed between the fixed seat and the hanging seat, a shade cloth that is wound around the winding shaft, a winding unit that is disposed between the hanging seat and one end of the winding shaft, and a counterweight member that is connected to one end of the shade cloth. The winding unit exerts a winding resilient force on the winding shaft to urge the winding shaft to rotate such that the shade cloth is wound on the winding shaft. The counterweight member has a weight that matches the winding resilient force. The resistance mechanism is disposed between the fixed seat and another end of the winding shaft.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary perspective view of a conventional cordless roller blind disclosed in Taiwanese Patent No. 1542307.

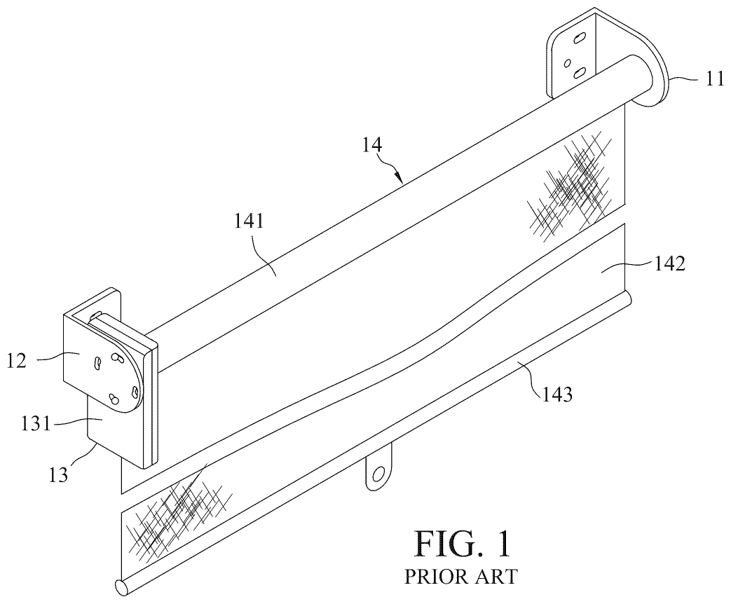

FIG. 2 is a fragmentary front view illustrating the conventional cordless roller blind.

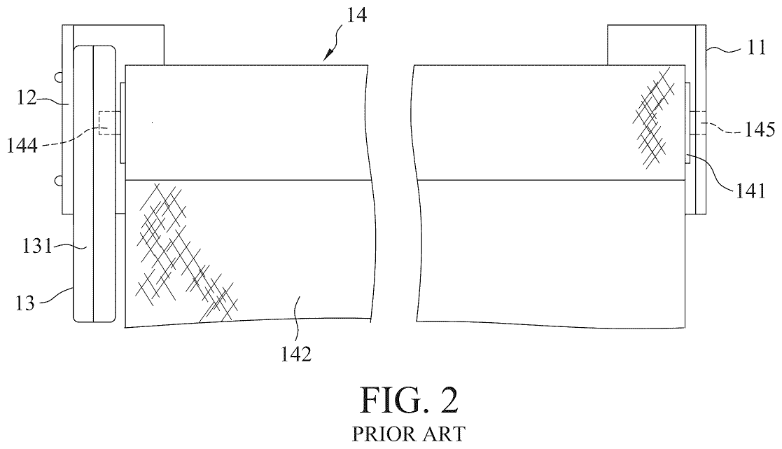

FIG. 3 is a side view of an interior structure of a winding unit of the 5 conventional cordless roller blind.

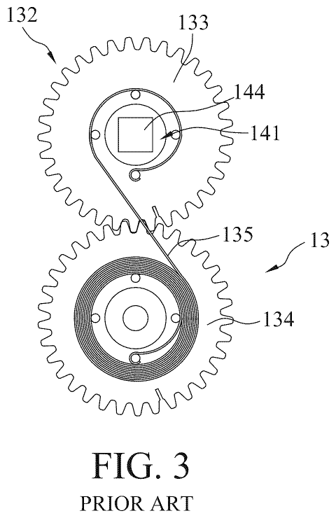

FIG. 4 is a fragmentary perspective view of an embodiment of a cordless roller blind according to the present disclosure.

FIG. 5 is a fragmentary sectional view illustrating part of the embodiment.

FIG. 6 is a perspective view of a resistance mechanism of the embodiment.

FIG. 7 is an exploded perspective view illustrating a structure of the resistance mechanism.

FIG. 8 is a sectional view illustrating the resistance mechanism.

FIG. 9 is a fragmentary, enlarged sectional view illustrating an assembly of a gear of the embodiment and a mounting section of a shaft of the embodiment.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

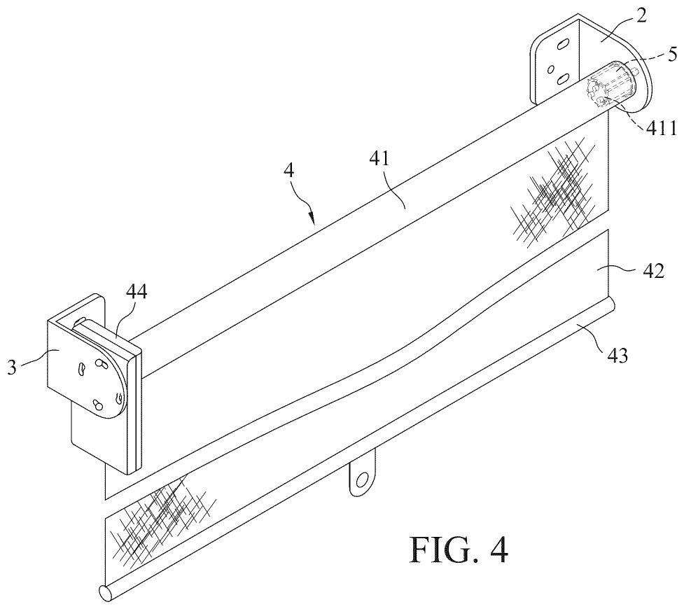

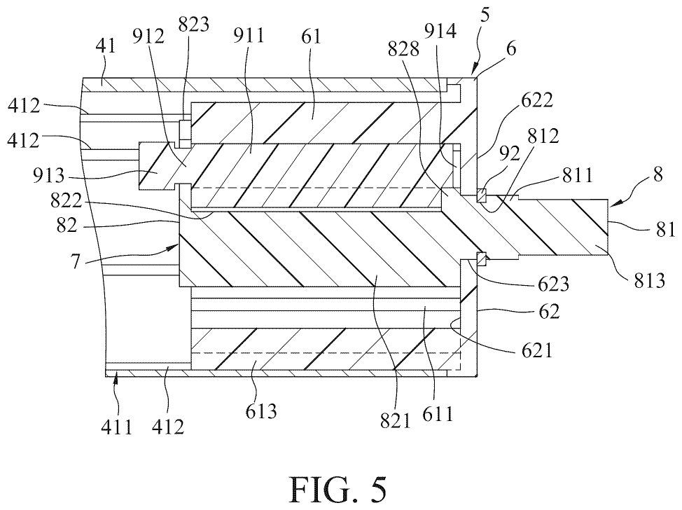

Referring to FIGS. 4 and 5, an embodiment of a cordless roller blind according to the present disclosure is adapted to be mounted to a wall surface (not shown). The cordless roller blind includes a fixed seat 2 and a hanging seat 3 that are spaced apart from each other in a left-right direction and that are adapted to be mounted to the wall surface, a roller blind mechanism 4 that is disposed between the fixed seat 2 and the hanging seat 3 and that is connected to the hanging seat 3, a resistance mechanism 5 that is disposed between the roller blind mechanism 4 and the fixed seat 2. Because the fixed seat 2 and the hanging seat 3 are conventional components, and are not important aspects of this disclosure, detailed descriptions thereof are omitted.

The roller blind mechanism 4 includes a winding shaft 41 that extends in the left-right direction and that is disposed between the fixed seat 2 and the hanging seat 3, a shade cloth 42 that is wound around the winding shaft 41, a counterweight member 43 that is connected to a free end of the shade cloth 42, and a winding unit 44 that is disposed between the hanging seat 3 and one end of the winding shaft 41. The winding unit 44 exerts a winding resilient force on the winding shaft 41 to urge the winding shaft 41 to rotate such that the shade cloth 42 is wound on the winding shaft 41 (i.e., the free end of the shade cloth 42 is moved upwardly). The counterweight member 43 has a weight that matches the winding resilient force. An inner circumferential surface of the winding shaft 41 that is adjacent to the fixed seat 2 is formed with a first locking structure 411. In this embodiment, the first locking structure 411 has a plurality of locking grooves 412 that extend in the left-right direction and that are spaced apart circumferentially on the inner circumferential surface of the winding shaft 41 around an axis which extends in the left-right direction.

Through a structural design of the roller blind mechanism 4, the shade cloth 42 can stay in any position after being pushed upwardly or pulled downwardly. Because the roller blind mechanism 4 is a component of a conventional cordless roller blind, and is not an important aspect of this disclosure, a detailed description thereof is omitted.

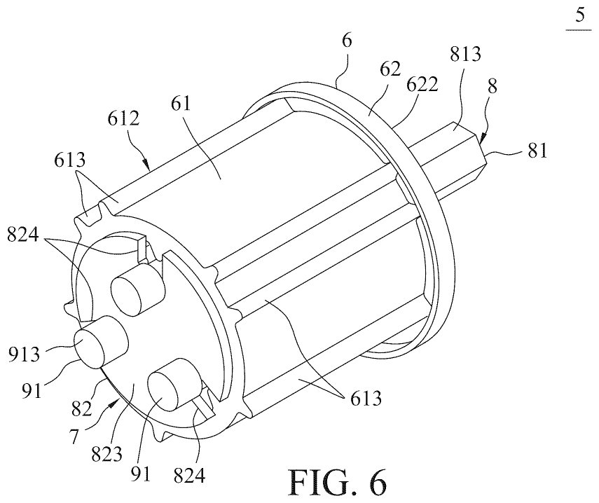

Referring to FIGS. 5 to 8, the resistance mechanism 5 is disposed between the fixed seat 2 and another end of the winding shaft 41 that is adjacent to the fixed seat 2, and includes a housing 6 that is co-rotatably mounted to the another end of the winding shaft 41, and a resistance module 7 that is disposed in the housing 6 and that is connected to the fixed seat 2.

The housing 6 includes a tubular wall 61 that is hollow, that surrounds the axis, that extends in the left-right direction, and that is coaxially inserted into the another end of the winding shaft 41, and an end wall 62 that is connected to one end of the tubular wall 61 and that is limited by and abuts against an end surface of the winding shaft 41. An inner circumferential surface of the tubular wall 61 is provided with a teeth structure 611 that extends along an inner periphery of the tubular wall 61 to surround the axis. An outer circumferential surface of the tubular wall 61 is formed with a second locking structure 612 that surrounds the axis and that is disposed along an outer periphery of the tubular wall 61.

In this embodiment, the second locking structure 612 has a plurality of convex ribs 613 that protrude radially about the axis, that extend in the left-right direction, and that respectively engage the locking grooves 412 of the first locking structure 411 such that the second locking structure 612 is co-rotatably connected to the first locking structure 411. The housing 6 is co-rotatable with and fixedly inserted into the winding shaft 41 through connection between the second locking structure 612 and the first locking structure 411.

The end wall 62 has an inner side surface 621 that faces an interior of the tubular wall 61, an outer side surface 622 that faces away from the tubular wall 61, and a through hole 623 that extends through the inner side surface 621 and the outer side surface 622.

The resistance module 7 includes a shaft 8 that extends along the axis through the end wall 62 in the left-right direction and that is surrounded by the tubular wall 61 (i.e., the shaft 8 is coaxially disposed in the tubular wall 61), three gears 91 that are spaced apart from each other along a periphery of the shaft 8, and a limiting member 92 that is mounted to the shaft 8 and that limits the shaft 8 at the end wall 62. Each of the gears 91 is mounted to the shaft 8, and is rotatable relative to the shaft 8 about a rotation axis that extends in the left-right direction. Each of the gears 91 meshes with the teeth structure 611 of the tubular wall 61, and is driven to rotate relative to the shaft 8 by rotation of the teeth structure 611 when the tubular wall 61 rotates.

The shaft 8 has a fixed section 81 that extends along the axis through the through hole 623 of the end wall 62 in the left-right direction, and a mounting section 82 that is coaxially connected to the fixed section 81 and that is located in the tubular wall 61. The fixed section 81 has a rotating shaft portion 811 that extends through the through hole 623, and a mounting portion 813 that extends coaxially from the rotating shaft portion 811 and that is fixedly and non-rotatably inserted into the fixed seat 2. The rotating shaft portion 811 has an engaging groove 812 that is recessed from an outer circumferential surface thereof, that is located outside the end wall 62, and that is adjacent to the outer side surface 622 of the end wall 62.

The mounting section 82 has a middle shaft 821 that is coaxially connected to one end of the rotating shaft portion 811 of the fixed section 81, and a first mounting wall 823 and a second mounting wall 828 that are spaced apart from each other in the left-right direction and that respectively protrude radially from two opposite ends of the middle shaft 821. The middle shaft 821 has three accommodating grooves 822 that are formed in an outer circumferential surface thereof, that are located between the first mounting wall 823 and the second mounting wall 828, that are arranged along a periphery thereof, and that extend in the left-right direction. The first mounting wall 823 and the second mounting wall 828 are respectively distal from and proximate to the end wall 62. The second mounting wall 828 of the mounting section 82 of the shaft 8 is limited by and abuts against the inner side surface 621 of the end wall 62.

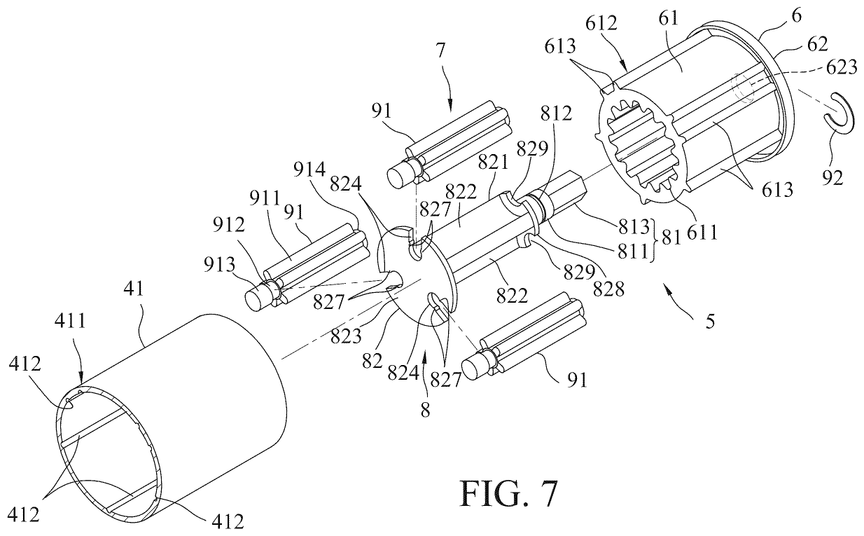

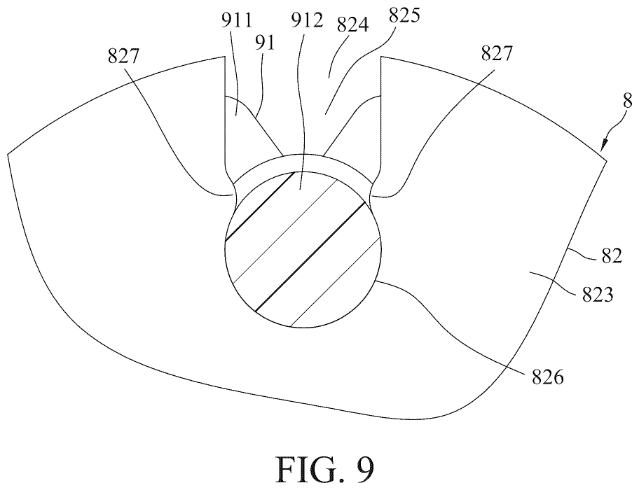

Referring to FIGS. 7 and 9, the first mounting wall 823 has three first connecting grooves 824 that are arranged along an outer periphery thereof, that are recessed inwardly from an outer circumferential surface thereof, that extend therethrough in the left-right direction, and that are respectively in spatial communication with the accommodating grooves 822. The first mounting wall 823 further has six position-limiting portions 827 that are divided into three pairs each of which extend into a respective one of the first connecting grooves 824. Specifically, in each of the first connecting grooves 824, the respective pair of position-limiting portions 827 extend toward each other to divide the first connecting groove 824 into a coupling groove part 825 and a position-limiting groove part 826 that are arranged radially inwardly and that are in spatial communication with each other (i.e., for each of the first connecting grooves 824, the position-limiting groove part 826 is located between the axis and the coupling groove part 825). The second mounting wall 828 has three second connecting grooves 829 that are spaced apart from each other along an outer periphery thereof, that are recessed inwardly from an outer circumferential surface thereof, that extend therethrough in the left-right direction, and that are respectively in spatial communication with the accommodating grooves 822. It is noted that only two of the second connecting grooves 829 are visible due to the viewing angle in FIG. 7.

Each of the gears 91 is rotatably connected between the first mounting wall 823 and the second mounting wall 828. The gears 91 are respectively accommodated in the accommodating grooves 822. Each of the gears 91 has a gear section 911 that is between the first mounting wall 823 and the second mounting wall 828, that meshes with the teeth structure 611, and that is elongated in the left-right direction, a first connecting section 912 that coaxially extends from one end of the gear section 911 which is adjacent to the first mounting wall 823, a blocking section 913 that protrudes from one end of the first connecting section 912 which is opposite to the gear section 911 and that has a diameter greater than a diameter of the first connecting section 912, and a second connecting section 914 that coaxially extends from another end of the gear section 911 which is adjacent to the second mounting wall 828.

Referring to FIGS. 5, 7, and 9, each of the gears 91 is mounted to the mounting section 82 of the shaft 8. When assembling the gears 91 and the mounting section 82, for each of the gears 91, the first connecting section 912 is pushed into a respective one of the first connecting grooves 824 of the first mounting wall 823 such that the first connecting section 912 is moved past the coupling groove part 825 of the first connecting groove 824, pushes the respective pair of position-limiting portions 827 away from each other, and is positioned in the position-limiting groove part 826 of the first connecting groove 824. Consequently, the first connecting section 912 of each of the gears 91 rotatably extends through the position-limiting groove part 826 of the respective one of the first connecting grooves 824 in the left-right direction, is limited in the position-limiting groove part 826 of the respective one of the first connecting grooves 824 by the respective pair of position-limiting portions 827, and is separable from the respective one of the first connecting grooves 824 in a radial direction of the mounting section 82 of the shaft 8. For each of the gears 91, the blocking section 913 and the gear section 911 are respectively limited at two opposite sides of the first mounting wall 823. The second connecting section 914 of each of the gears 91 is rotatably coupled to a respective one of the second connecting grooves 829, and the gear section 911 of each of the gears 91 is rotatably coupled to the respective one of the accommodating grooves 822.

The limiting member 92 is a C-shaped buckle that engages the engaging groove 812 of the rotating shaft portion 811, and that is limited by and abuts against the outer side surface 622 of the end wall 62 so that the shaft 8 is not movable relative to the housing 6 in the left-right direction. Because the limiting member 92 may have many types, implementation thereof is not limited to the disclosed embodiment.

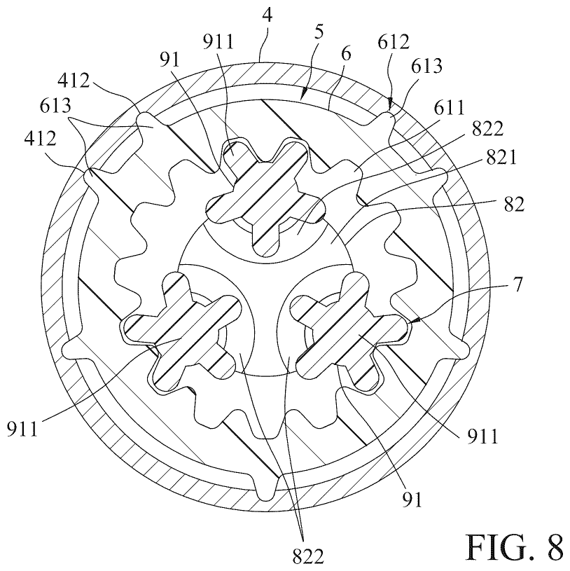

Referring to FIGS. 4 and 8, when the cordless roller blind of this disclosure is in use, there is static friction between the teeth structure 611 of the tubular wall 61 of the housing 6 and each of the gears 91 of the resistance module 7.

Because the housing 6 is mounted to the winding shaft 41 and the shaft 8 of the resistance module 7 is non-rotatably mounted to the fixed seat 2, the static friction between the resistance module 7 and the housing 6 serves as resistance that prevents rotation of the winding shaft 41. Hence, when a user wants to adjust a length of an unwound section of the shade cloth 42 by pushing the shade cloth 42 upwardly or pulling the shade cloth 42 downwardly, the user has to exert a force on the shade cloth 42 to overcome the static friction between the resistance module 7 and the housing 6 so as to rotate the winding shaft 41 to adjust the length of the unwound section of the shade cloth 42. When the user stops pushing or pulling the shade cloth 42, by virtue of the weight of the counterweight member 43 matching the winding resilient force of the winding unit 44, and by virtue of the static friction serving as the resistance that prevents the rotation of the winding shaft 41, the rotation of the winding shaft 41 is stopped immediately, thereby urging the shade cloth 42 to stay in a position in which the user stops pushing or pulling the shade cloth 42.

In summary, through a structural design of the housing 6 and the resistance module 7 of the resistance mechanism 5, the static friction between the housing 6 and the resistance module 7 serves as the resistance to the rotation of the winding shaft 41. Hence, even when a counterweight design of the counterweight member 43 has a slightly large deviation, the shade cloth 42 may still stay in any position in which the user stops pushing or pulling the shade cloth 42. Therefore, the cordless roller blind of this disclosure may have a relatively larger tolerance of the counterweight design of the counterweight member 43, and is indeed novel and convenient to use, and the purpose of the present disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A resistance mechanism for a cordless roller blind, adapted to be installed between a winding shaft and a fixed seat of the cordless roller blind that are rotatable relative to each other, the resistance mechanism comprising:
a housing adapted to be co-rotatably mounted to the winding shaft, the housing including a tubular wall that is hollow and that surrounds an axis which extends in a left-right direction, and an end wall that is connected to one end of the tubular wall, an inner circumferential surface of the tubular wall being provided with a teeth structure that surrounds the axis; and
a resistance module including a shaft that extends along the axis through the end wall and that is surrounded by the tubular wall, and a plurality of gears each of which is mounted to the shaft and rotatable relative to the shaft about a rotation axis extending in the left-right direction, the shaft being adapted to be non-rotatably inserted into the fixed seat, the gears being spaced apart from each other along a periphery of the shaft and meshing with the teeth structure, each of the gears being driven to rotate relative to the shaft by rotation of the teeth structure of the tubular wall when the tubular wall rotates.

2. The resistance mechanism as claimed in claim 1, wherein the shaft has a fixed section that extends along the axis through the end wall and that is adapted to be fixedly inserted into the fixed seat, and a mounting section that is coaxially connected to one end of the fixed section and that is located in the tubular wall, the mounting section having a first mounting wall and a second mounting wall that are spaced apart from each other in the left-right direction, each of the gears being rotatably connected between the first mounting wall and the second mounting wall.

3. The resistance mechanism as claimed in claim 2, wherein the mounting section of the shaft further has a plurality of accommodating grooves that are formed in an outer circumferential surface thereof and that are located between the first mounting wall and the second mounting wall, the gears being respectively accommodated in the accommodating grooves.

4. The resistance mechanism as claimed in claim 3, wherein the first mounting wall has a plurality of first connecting grooves that are arranged along an outer periphery thereof, that are recessed inwardly from an outer circumferential surface thereof, and that extend therethrough in the left-right direction, each of the gears having a gear section that is between the first mounting wall and the second mounting wall and that meshes with the teeth structure, a first connecting section that rotatably extends through a respective one of the first connecting grooves in the left-right direction, and a blocking section that has a diameter greater than a diameter of the first connecting section and that is limited at one side of the first mounting wall opposite to the gear section, the first mounting wall further having a plurality of position-limiting portions that extend into the first connecting grooves such that the first connecting section of each of the gears is limited in the respective one of the first connecting grooves and is separable from the respective one of the first connecting grooves in a radial direction of the mounting section of the shaft.

5. The resistance mechanism as claimed in claim 4, wherein the second mounting wall has a plurality of second connecting grooves that are spaced apart from each other along an outer periphery thereof, that are recessed inwardly from an outer circumferential surface thereof, and that extend therethrough in the left-right direction, each of the gears further having a second connecting section that is rotatably coupled to a respective one of the second connecting grooves.

6. The resistance mechanism as claimed in claim 4, wherein the gear section of each of the gears is elongated in the left-right direction.

7. The resistance mechanism as claimed in claim 2, wherein the end wall has an inner side surface that faces the tubular wall, and an outer side surface that faces away from the tubular wall, the mounting section of the shaft being limited by and abutting against the inner side surface of the end wall, the fixed section of the shaft having a rotating shaft portion that extends through the end wall, and a mounting portion that extends coaxially from the rotating shaft portion and that is adapted to be fixedly inserted to the fixed seat, the rotating shaft portion having an engaging groove that is recessed from an outer circumferential surface thereof, the resistance module further including a limiting member that engages the engaging groove, and that is limited by and abuts against the outer side surface of the end wall.

8. The resistance mechanism as claimed in claim 1, an inner circumferential surface of the winding shaft being formed with a first locking structure, wherein the tubular wall is coaxially inserted into the winding shaft, and an outer circumferential surface of the tubular wall is formed with a second locking structure that is adapted to be co-rotatably connected to the first locking structure.

9. The resistance mechanism as claimed in claim 8, the first locking structure of the winding shaft having a plurality of locking grooves that are spaced apart from each other, that surrounds the axis, and that extend in the left-right direction, wherein the second locking structure of the tubular wall has a plurality of convex ribs that protrude radially about the axis and that respectively engage the locking grooves.

10. A cordless roller blind adapted to be mounted to a wall surface, the cordless roller blind comprising:
a fixed seat and a hanging seat spaced apart from each other in a left-right direction and adapted to be mounted to the wall surface;
a roller blind mechanism including a winding shaft that extends in the left-right direction and that is disposed between the fixed seat and the hanging seat, a shade cloth that is wound around the winding shaft, a winding unit that is disposed between the hanging seat and one end of the winding shaft, and a counterweight member that is connected to one end of the shade cloth, the winding unit exerting a winding resilient force on the winding shaft to urge the winding shaft to rotate such that the shade cloth is wound on the winding shaft, the counterweight member having a weight that matches the winding resilient force; and
the resistance mechanism as claimed in claim 1, the resistance mechanism being disposed between the fixed seat and another end of the winding shaft.
